(19) United States
(12) Patent Application Publication
(10) Pub. No.: US 2009/0211218 A1
(43) Pub. Date: Aug. 27, 2009

(54) POLYCONDENSATE FIBERS

(75) Inventors: Jacobus Antonius JA Loontjens, Meerssen (NL); Harm H. van der Werff, Bunde (NL); Marko M. Dorschu, Beek (NL); Theo Joseph TJ Cuypers, Dilsen-Stokkem (BE)

Correspondence Address: NIXON & VANDERHYE, PC, 901 NORTH GLEBE ROAD, 11TH FLOOR, ARLINGTON, VA, 22203, US

(73) Assignee: DSM IP ASSETS B.V., Heerlen (NL)

(21) Appl. No.: 11/995,424

(22) PCT Filed: Jun. 13, 2006
(86) PCT No.: PCT/EP06/05762

§ 371 Date: Sep. 12, 2008

(30) Foreign Application Priority Data
Jul. 15, 2005 (EP) 05076630.2

(51) Int. Cl. D02G 3/02; C08F 290/14; C08G 63/91; D01D 5/084

(52) U.S. Cl. 57/243; 525/50; 525/446; 525/437; 264/178 F

(57) ABSTRACT

The invention relates to a method of increasing the molecular mass of a polycondensate in solution, wherein polycondensate is reacted with at least one chain extender out of the group consisting of bislactams, cyclic amino ethers, siloxanes and thiols. The invention further relates to a high molecular mass polycondensate in solution, wherein the polycondensate has an intrinsic viscosity as measured in hexafluoroisopropanol of at least 0.9 dl/g and a molecular mass distribution (Mw/Mn) of less than (2). The invention further relates to a process for producing a filament or film of a polycondensate comprising forming a solution of polycondensate by the method according to the invention, extruding the solution through a spinneret or a slot die, through air and into a cooling bath to form a gel filament or film, optionally removing residual solvent from the filament or film and drawing the filament or film at least (15), preferably at least (25) times. The invention further relates to shaped articles obtainable by the process thereof.

The invention relates to a method of increasing the molecular mass of a polycondensate in solution and the use of such solution to produce a high molecular mass polycondensate shaped article, preferably a fiber or a film.

The production of fibers and films of a polycondensate is known from JP 61-207616. JP 61-207616 describes a gel spinning process of polyethylene terephthalate (PET) dissolved in dichloro-acetic acid. Because of the relatively good solubility of PET in dichloro-acetic acid a low concentration of PET with an intrinsic viscosity of 5 dl/g (as measured in o-chlorophenol at 25° C.) results in a spinnable solution. Fibers spun from a 6% (w/w) solution of PET having an intrinsic viscosity (IV) of 1.6 and drawn 20-fold had a tenacity of 26 g/denier and elongation at break of 5.1%; fibers spun from a 4% (w/w) solution of PET having an IV of 5.0 and drawn 22.5 times had a tenacity of 31.6 g/denier and elongation at break of 5.2%.

However, because dichloro-acetic acid is a highly dangerous compound, especially in an industrial process, a process in an alternative solvent having less toxicity problems has been described in EP 0 336 556 A2. In this process the PET is dissolved in diphenylene ether or a mixture of diphenylene ether and biphenyl comprising between 0 and 40% by weight of biphenyl and between 100 to 60% by weight of diphenylene ether.

A disadvantage of this solvent is that the solubility of PET is less than in dichloro-acetic acid, reason for which spinning must be carried out at higher temperatures. At higher temperatures however, the viscosity of the PET solution must be further increased to obtain a spinnable solution. In EP 0 336 556 A2 this was realized by increasing the concentration of the PET in the solvent up to 30 wt %. No strength was reported for the thus obtained fiber.

An alternative method to increase the viscosity of the solution is to increase the molecular mass (also called molecular weight) of the polymer. It is known in the art that fibers and films are preferably spun from a solution of a polycondensate, said polycondensate having a molecular mass as high as possible. A polycondensate with a high molecular mass, however, is difficult to prepare and even more difficult to dissolve without again decreasing its molecular mass due to degradation reactions.

It is already known from U.S. Pat. No. 2,829,153 that in the process of increasing the molecular weight of a polycondensate, physical reasons prevent the polycondensation reaction from proceeding to completion. The polycondensation reaction, which is typically carried out in a melt, (e.g. the polycondensation of polyethylene terephthalate) depends on the rate of diffusion and elimination of monomers (in this case ethylene glycol) through the polymer melt, a process that becomes progressively more difficult as the viscosity rises.

A further complication is that thermal decomposition occurs at the temperatures used in melt polycondensation, which tends to reduce the reaction rate due to an increase in carboxyl and vinyl end groups and a decrease in hydroxyl end groups. Consequently it has been difficult to attain a molecular mass in excess of about IV 0.9 dl/g (measured in o-chlorophenol) and a carboxyl value of below 15 equiv/kg polyethylene terephthalate. The intrinsic viscosity is a property of the polycondensate that is proportional with its molecular mass, as is the relative viscosity thereof in a solvent.

The current technology to make high molecular mass polycondensates, such as polyalkylene terephthales, from lower molecular mass precursors is by a solid state post-condensation process (SSP). In such a process powder or pellets of the polymers are heated up to about 20° C. below their melting temperature for a period of time of between 20 to 50 hours, sometimes even longer. The viscosity obtained by this process is limited by the diffusion in the pellets. U.S. Pat. No. 4,792,573 describes the preparation of high molecular mass PET by making first a solution of PET in trifluoro acetic acid, then a foam from that solution, followed by a solid state post-condensation of this foam. High molecular mass PET is obtained by this method, however, this process is not industrially feasible. A further problem is the difficulty to dissolve a high molecular mass polycondensate. Similar problems are faced in WO 01/88004 A2, where the polymers are first ground before the SSP treatment. The preparation of thin layers of fine powders to decrease the diffusion pathway is costly.

A further problem is the difficulty to dissolve a high molecular mass polycondensate.

This problem has been disclosed and solved in GB 2229187 for PET by dissolving a relatively low molecular mass PET polymer in a suitable solvent, and increasing the PET molecular mass in the solution. The molecular mass is increased by chain extension carried out by reacting a diisocyanate compound with end groups of the polymer, in a hot solution of the polymer.

A disadvantage of this method however is, that diisocyanates tend to cause side reactions that may form trifunctional groups; as e.g. described by Karel Dusek et al. in Macromolecules 1990, 23, 1774-1781. Formation of such trifunctional groups, promotes polymer chain branching and even the formations of a network being detrimental for fiber or film spinning.

An object of the present invention is to provide a method for increasing the molecular mass of a polycondensate in solution without causing branching.

Surprisingly, the object of the present invention is achieved in that the polycondensate is reacted with at least one chain extender out of the group consisting of bislactams, cyclic amino ethers, siloxanes, and thiols.

We have surprisingly found that the molecular mass of the polycondensate is increased without causing branching, by adding to the polycondensate solution one or more of said chain extenders. The absence of branching was proved by a linear Mark-Houwink relation. A further advantage is that a low molecular mass distribution (Mw/Mn) of the polycondensate in solution is obtained. An even further advantage of the method of the present invention is that said chain extenders are much less toxic than isocyanates, being therefore suitable to be used in an industrial process without posing safety hazards.

In the method of the invention a polycondensate bulk material generally comprises polycondensate chains having acid (—COOH) end groups, basic (—OH or —NH₂) end groups, vinyl end groups or combinations thereof. The polycondensates preferably used in the present invention are polyesters, polyamides, polyethers or polycarbonates or mixtures thereof.

In a preferred embodiment, the polycondensate in the present invention is polybutylene terephthalate (PBT). PBT is preferred because of its hydrolytic stability and its favourable drawability of gel filaments, which result in PBT fibers with very high tensile strength. These properties make PBT suitable to be used in producing shaped articles with very good mechanical properties. In another preferred embodiment, the polycondensate in the present invention is polyethylene terephthalate (PET). Yet in another preferred embodiment the polycondensate in the present invention is a mixture of PBT and PET.

The solvents, which may be used in the method of the invention, are generally solvents with high boiling temperatures. On the other hand for convenience we prefer to use a solvent, which is liquid at, or near to, room temperature. Suitable solvents include diphenylene ether, a-methyl naphthalene, a mixture of diphenylene ether and biphenyl, biphenyl methane, compounds of the type C6H5-(CH2)n-C6H5 where n=1-4, dimethyl sulphoxide, N-formyl piperidine, N-methylpyrrolidone, biphenyl, nitrobenzene, 1,2,4-trichlorobenzene, 1,2-dimethoxybenzene, 1,3-dimethoxybenzene, ethylene carbonate, propylene carbonate, benzophenon, acetophenon and 1,2,4 trimethoxybenzene.

Though diphenylene ether may be used as the solvent, it is preferred to use a composition between 0 and 40% by weight of diphenylene and between 100 to 60% by weight of diphenylene ether. The two solvents in such a composition form a eutectic with a crystallization point of 12° C. at a concentration of 26.5% by weight of biphenyl. The crystallization point increases as the limits defined hereinbefore are approached and consequently the solvent in the spun filament would be solid at room temperature and therefore the fiber would be brittle. It is therefore preferred to operate the process using a solvent near the eutectic composition so that the spun fiber is not brittle at room temperature.

It is desirable to ensure that the polycondensate is dry before it is added to the dry solvent, because even the presence of small amounts of water will cause hydrolysis. This can be achieved by heating the polymer under vacuum at, say, 120° C. for, say, 18 hours. After addition to the solvent, the mixture is heated for example at between 200 and 240° C. under an atmosphere of nitrogen until a clear solution forms. Heating may then be continued for a further 30 minutes, with stirring.

The bislactams used in the method according to the invention may be prepared from lactams and diacid chlorides. The bislactams yield a strong enhancement of the viscosity of polycondensates by reacting exclusively with the —OH or the NH₂ end groups of the polycondensates. Preferably, the bislactams used according to the invention are carbonyl bislactams (CBL), said CBL preferably having a lactam ring comprising between 5 and 11 carbon atoms. The most preferred CBL is carbonyl biscaprolactam (CBC). An advantage of using CBC is that because of its low molecular weight, a less amount of CBC is needed when equimolar amounts of chain extenders are used.

A preferred cyclic amino ether used according to the invention is Phenylene BisOxazoline (PBO). An even more preferred cyclic amino ether is Phenylene BisOXazine (PBOX).

The siloxanes used according to the invention are preferably siloxanes according to formula 1, wherein R is an alkyl group with from 1 to 6 carbon atoms and n is an integer ranging from 0 to 100.

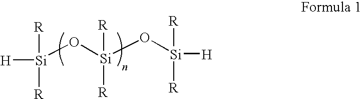

Preferably, to speed up the reaction a catalyst is used in combination with siloxanes. The preferred siloxane according to the invention is tetramethyldisiloxane (TMDS), said TMDS being preferably used in combination with a platinum catalyst.

It was found that a very good result, i.e. a strong increase in the molecular mass of the polycondensate, was obtained when the polycondensate was reacted in solution with both CBC and PBOX. It was found that even a better result, was obtained when the polycondensate was reacted in solution with CBC, PBOX and TMDS in the presence of a platinum catalyst.

The amount and combination of the chain extenders used according to the invention are chosen depending on the end groups of the polycondensate. Preferably, CBC, PBO, BPOX, and siloxane are each present in an amount that represents half the number of basic, acid and vinyl end groups of the polycondensate, respectively. The above-mentioned combination of chain extenders may also include thiols. When thiols are used, preferably also a compound out of the group of peroxides is added together with the thiols to facilitate the polycondensation reaction.

The advantage of using a combination of chain extenders is that the highest viscosity increase of the polycondensate is achieved. Furthermore, the chain extenders may be conveniently added to the solution comprising the polycondensate as a pre-formed solution in the solvent, or may be added without pre-formation of a solution.

The invention also relates to a high molecular mass polycondensate in solution, wherein the polycondensate has an intrinsic viscosity as measured in hexafluoroisopropanol of at least 0.9 dl/g and a molecular mass distribution (Mw/Mn) of less than 2. Preferably, said high molecular mass polycondensate has an IV of at least 1.5 dl/g, more preferably an IV of at least 2.5 dl/g, and even more preferably an IV of at least 3 dl/g.

The advantage of using such a solution of a high IV and low molecular mass distribution polycondensate according to the invention is that said solution can be easily spun into shaped articles at low temperatures, the extrudated shaped article exhibiting good mechanical properties that allow further processing. In addition to this, due to the reduced amount of branching, the polycondensate chains are easily oriented and thus a high degree of crystallisation of the chains is achieved during the solution processing, such as for example during stretching and drawing.

In a preferred embodiment, the high molecular mass polycondensate in solution is polybuthylene terephthalate (PBT). In another preferred embodiment, the high molecular mass polycondensate in solution is polyethylene terephthalate (PET).

The invention further relates to a shaped article comprising a high molecular mass polycondensate having an intrinsic viscosity as measured in hexafluoroisopropanol of at least 0.9 dl/g and a molecular mass distribution (Mw/Mn) of less than 2. Preferably, said high molecular mass polycondensate has an IV of at least 1.5 dl/g, more preferably an IV of at least 2 dl/g, even more preferably an IV of at least 2.5 dl/g, and even more preferably an IV of at least 3 dl/g.

The advantage of having shaped articles manufactured from a high IV and low molecular mass distribution polycondensate is that said shaped articles can be drawn without breaking in all stages of their manufacturing process in their fluid, gel or solid state, respectively, the final drawn shaped article having improved tensile strength and modulus as well as showing a strongly reduced creep behavior.

In a preferred embodiment said shaped article is a fiber or a film, most preferably a fiber. A fiber is herein understood as being a shaped article comprising a plurality of filaments.

The invention further relates to a process for the manufacture of a high molecular mass polycondensate shaped article wherein the solution comprising a high molecular mass polycondensate according to the method of the invention is used.

For simplicity, the high molecular mass polycondensate is going to be referred hereinafter as the polycondensate.

Also for simplicity the various stages of the process will now be described with reference to the production of filaments, but it will be appreciated that the process of the invention is also suitable for producing other shaped articles of a polycondensate, like films.

The solution made according to the method of the present invention may be either cooled to room temperature to produce a solid gel or stored for later use, or it may be transferred directly to a heated reservoir of a spinning unit. In the first case the solid gel is re-melted to reform the spinning solution and in the second case the spinning solution is allowed to cool or is heated to the required spinning temperature preferably between 185 and 250° C.; more preferably between 170 and 250° C., the exact temperature being determined by the polymer concentration, polymer molecular mass and solution viscosity. Above 250° C. there is a tendency for the solvent to boil whereas below 185° C. there is the likelihood of the spinning solution reverting to a solid gel, which would terminate the spinning process. Consequently, during spinning, all parts of the equipment in contact with the spinning solution must be kept above 185° C. to avoid spinning breakdowns; the gel melting temperature, depending on polymer concentration and molecular mass, being in the region of 200° C.

The solution made according to the method of the present invention can be readily spun into filaments, said filament being obtained by extruding the solution through a spinneret or a slot die to form a hot fluid filament, by transporting said hot fluid filament via an air-gap through air into a cooling bath to form a gel filament, optionally removing residual solvent from the gel filament, and drawing the filament preferably at least 4 times. More preferably the filament is drawn at least 10 times, even more preferably at least 15 times, most preferably at least 25 times.

Cooling of the fluid filament into solvent-containing gel filament may be performed with a gas flow, or by quenching the filament in a liquid cooling bath after passing an air-gap, the cooling bath preferably contains a non-solvent for the polycondensate solution. If gas cooling is applied, the air-gap is the length in air before the filaments are solidified. Preferably a liquid quench-bath is applied in combination with an air-gap, the advantage being that cooling conditions are better defined and controlled than by gas cooling. Although called air-gap, the atmosphere can be different than air; e.g. as a result of an inert gas like nitrogen flowing, or as a result of solvent evaporating from the filament. Preferable, there is no forced gas flow, or only of low flow rate. In a preferred embodiment, the filament being quenched in a bath containing a cooling liquid, which liquid is not miscible with the solvent, and the temperature of which is controlled. The quench bath conveniently contains water, maintained at room temperature (or at 35° C. when the solvent used is diphenylene ether which crystallizes at 27° C.) and the gel filament so formed is transported via low friction rollers to a winding unit. The hot liquid extrudate may have a specific gravity of below 1 at the temperature of spinning with the result that, if water is used in the coolant bath, the gel filament has a tendency to float on the surface of the water (and thereby affecting the quality of the product) unless this is overcome by increasing the spinning stretch ratio, also called draw down or fluid draw ratio DR_{fluid} (ratio of winding speed to linear extrusion rate). Alternatively, a coolant having a specific gravity of about 0.8 may be used.

Solvent removal from the gel filament can be performed by known methods, for example by evaporating a relatively volatile solvent, by using an extraction liquid, or by a combination of both methods.

In a preferred embodiment, the process according to the invention is used to produce a multifilament polycondensate yarn. Preferably a multi hole spinneret is used, thus producing a multifilament polycondensate yarn. A multifilament polycondensate yarn not only has a high tensile strength, but also low levels of fluffing (fluffing results from the presence of broken filaments) can be obtained, especially if the draw ratios have been optimised.

The process for making a multifilament polycondensate yarn according to the invention further comprises, in addition to drawing the fluid or solution filaments, drawing the filaments in at least one drawing step performed on the semi-solid or gel filaments and/or on solid filaments after cooling and at least partial removal of solvent, with a draw ratio of at least 4. Preferably, drawing is performed in more than two steps, and preferably at different temperatures with an increasing profile between room temperature and no more than 10 degrees above the melting temperature of the polycondensate. A 3-step draw ratio applied on (semi-) solid filaments is represented as DR_{solid}=DR_{solid1}*DR_{solid2}*DR_{solid3}; i.e. it is composed of the draw ratios applied in each drawing step.

Preferably the polycondensate in the present invention is polybutylene terephthalate (PBT). PBT is preferred because its hydrolytic stability and favourable drawability of gel filaments, which results in fibres with very high tensile strength.

It is found that a draw ratio DR_{solid} of at least about 15, and preferably at least 25 can be applied, to reach the highest tensile properties of the yarn obtainable for a given DR_{fluid}. As a result of improved drawability and strength of partly drawn filaments in the process according to the invention, relatively high draw ratios, preferably in the range 5-30, may be applied without frequent filament breakage occurring, also depending on the applied draw ratio on fluid filaments. The spun PBT filaments are preferably drawn at temperatures up to 225° C.

The process according to the invention may further comprise additional steps known in the art, like for example applying a spin finish or sizing agent to the multifilament polycondensate yarn.

An as-produced multifilament polycondensate yarn according to the invention can further be assembled into yarns, or ropes etc, of higher titer or linear density.

Such high-strength yarn is very useful for various applications, like making of heavy-duty ropes and cables, or for making ballistic-resistant composites offering improved protection level, or reduced weight. Yarn of relatively low titer, containing for example from 5 to 300 filaments, but of extremely high strength is a.o. very suited for making high-strength surgical sutures and cables, or other medical implants. For medical applications the amount of other components or foreign materials in the yarn is very important, in addition to its mechanical properties.

The invention therefore also specifically relates to a polycondensate multifilament yarn according to the invention containing less than 150 ppm of residual solvent, specifically of solvent having a boiling point at atmospheric conditions of less than 275° C., preferably containing less than 100, 75, or even less than 50 ppm of solvent, and to medical implants containing such yarn.

The invention specifically relates to a PBT multifilament yarn containing at least 20 filaments, the yarn being made from PBT of an IV of at least 1.5 dl/g and a M_{w}/Mₙ of no more than 2. Especially for making ropes, multifilament yarn of such high strength, which also shows an elongation at break of more than about 5% is advantageous, because of higher strength efficiency of such ropes.

Therefore, the invention further relates to a PBT multifilament yarn comprising at least 20 filaments, characterized in that the PBT has an IV of at least 1.5 dl/g, preferably at least 3 and more preferably at least 4.5 dl/g and an M_{w}/Mₙ of less than 2.

The invention further relates to various semi-finished and end-use articles containing the high-performance polycondensate multi-filament yarn according to the invention, or a high-performance polycondensate multi-filament yarn obtainable by the process according to the invention. Examples of such articles include various ropes and cords, fishing nets, sports equipment, medical implants like suture and cables, and ballistic-resistant composites. In most of these applications the tensile strength of the yarn is an essential parameter determining performance of the article.

Ropes especially include heavy-duty ropes for application in marine and offshore operations, like anchor handling, seismic operations, mooring of drilling rigs and production platforms, and towing. Preferably, such ropes contain at least 50 mass % of the yarn according to the invention, more preferably at least 75, or even 90 mass %. Most preferably, the rope consists essentially of polycondensate yarn according to the invention. Such products also show improved performance, like reduced creep and longer time to rupture under continuous loading conditions, in addition to higher strength.

The invention further relates to the application of the fibres in flexible composites as a rubber reinforcement, such as in V-belts or as tire cords. The fibres can also be applied in rigid composites, optionally together with glass or carbon fibres, for those products where high impact resistance is desired, e.g. for canoes that are used in wild rivers.

The invention further relates to a multi-layer ballistic-resistant assembly containing a plurality of mono-layers comprising polycondensate yarn according to the invention, and to ballistic-resistant articles comprising such an assembly. The polycondensate yarn can be present in various forms in a mono-layer, including woven and non-woven fabrics. Preferably, the mono-layers contain uni-directionally oriented polycondensate filaments; with the fiberdirection in each mono-layer being rotated with respect to the fiber direction in an adjacent mono-layer. The mono-layers may further comprise a binder material, basically to hold the filaments together. The binder material can have been applied by various techniques; for example as a film, as a transverse bonding strip or fibres (transverse with respect to the unidirectional filaments), or by impregnating and/or embedding the filaments with a matrix, e.g. with a solution or dispersion of matrix material in a liquid. The amount of binder material is preferably less than 30 mass % based on the mass of the layer, more preferably less than 20 or 15 mass %. The mono-layers may further comprise small amounts of auxiliary components, and may comprise other filaments. Preferably the mono-layers only comprise polycondensate filaments as reinforcing fibres. Such mono-layers are therefore also referred to as mono-layers consisting essentially of polycondensate filaments.

The multi-layer ballistic-resistant assembly can also be an assembly of at least two preformed sheet layers, a sheet layer comprising at least two mono-layers comprising high-performance fibres and a binder material, and optionally other layers, like a film or fabric; that have been consolidated or attached to each other. Such multi-layer ballistic-resistant assemblies or panels, and their manufacture are known in the art, for example from U.S. Pat. No. 4,916,000, U.S. Pat. No. 4,623,574, EP 0705162 A1 or EP 0833742 A1.

For so-called hard ballistic applications like vehicle armouring, rigid panels that have been (compression-) moulded from a plurality of mono-layers containing polycondensate yarn are generally applied. For soft ballistic applications like body armour, flexible panels assembled from a plurality of mono-layers containing polycondensate yarn, e.g. by stacking mono-layers or preformed sheets and securing the stack by for example stitching at the corners or around the edges, or by placing inside an envelope, are preferred.

The invention will now be described with reference to the following examples.

### EXAMPLES

ηᵣₑₗ is measured in m-cresol at room temperature.
IV is measured in hexafluoroisopropanol.

### Comparative Experiment A and Examples 1 to 4

PBT T01060 (ηᵣₑₗ=1.85 in m-cresol) from DSM was dried for 18 hours, at 120° C. before use. The hydroxy end group concentration is 78 mmol/kg and the acid end group concentration is 32 mmol/kg.

Dowtherm A, a mixture of diphenylene ether and diphenylene, was added to a reactor, provided with mechanical stirrer and a reflux condenser, and heated to 200° C. To remove residues of water the heated solvent was evacuated three times before use. After about 30 minutes the PBT was completely dissolved, giving a clear solution. The stirrer was provided with a torque registration system. The torque is a good measure for the solution viscosity, which is a good indication for the molecular mass of the polymer. The results obtained when using 37 wt % of PBT in Dowtherm are given in table 1.

TABLE 1

| Comparative | | | | CBC | PBOX | Final |
|---|---|---|---|---|---|---|
| Experiment/ | Dowtherm | PBT | Concentration | (wt % to | (wt % to | torque |
| Examples | (gram) | (gram) | (wt %) | PBT) | PBT) | (N · cm) |
| A | 97 | 59 | 38.8 | 0 | 0 | 1 |
| 1 | 99 | 59 | 37.3 | 0.50 | 0.20 | 8.2 |
| 2 | 98 | 60 | 38.0 | 0.98 | 0.39 | 16.7 |
| 3 | 95 | 59 | 38.3 | 1.48 | 0.59 | 12.6 |
| 4 | 97 | 60 | 38.2 | 2.44 | 0.98 | 6.7 |

CBC = carbonyl biscaprolactam;
PBOX = phenylene bisxoazine.

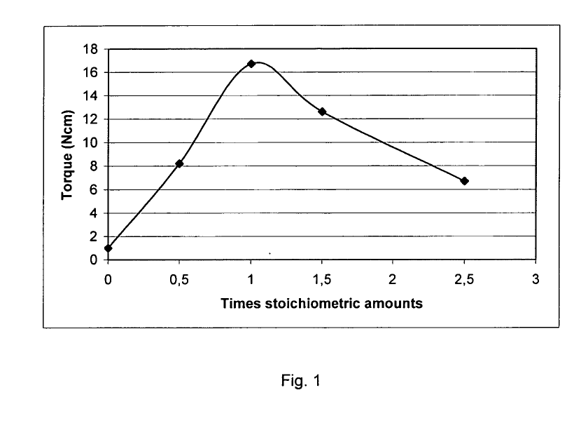

FIG. 1 shows the relation of torque versus the amount of chain extenders expressed as the number of times the stoichiometric amounts added (PBT concentration is about 38 wt %). It can be seen that near the stoichiometric amounts of chain extender the maximally obtainable viscosity is achieved.

### Comparative Experiment B and Examples 5 to 8

The results obtained when using 30 wt % of PBT in Dowtherm are given in table 2. The experimental conditions were similar as in the examples 2 to 4.

TABLE 2

| Comparative | | | | CBC | PBOX | |
|---|---|---|---|---|---|---|
| Experiment/ | Dowtherm | PBT | Concentration | (wt % to | (wt % to | Torque |
| Examples | (gram) | (gram) | (wt %) | PBT) | PBT) | (Ncm) |
| B | 99 | 43 | 30.3 | 0 | 0 | 0.5 |
| 5 | 99 | 43 | 30.3 | 0.49 | 0.20 | 1.6 |
| 6 | 102 | 44 | 30.1 | 0.98 | 0.39 | 8.7 |
| 7 | 100 | 43 | 30.0 | 1.47 | 0.58 | 8.2 |
| 8 | 97 | 42 | 30.2 | 2.50 | 1.00 | 4.1 |

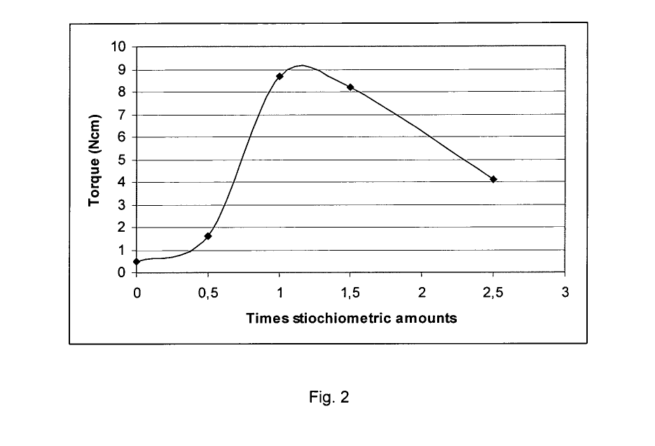

FIG. 2 shows the relation of torque versus the amount of chain extenders expressed as the number of times the stoichiometric amounts added (PBT concentration is about 30 wt %).

It can be seen that near the stoichiometric amounts of chain extender the maximum viscosity is obtained.

### Example 9

PBT T08200 (ηᵣₑₗ=2.40 in m-cresol) from DSM is dried for 18 hours, at 120° C. before use. The hydroxy end group concentration is 39 mmol/kg and the acid end group concentration is 17 mmol/kg.

Dowtherm A, a mixture of diphenylene ether and diphenylene (95.4 g), was added to a reactor, provided with mechanical stirrer and a reflux condenser, and heated to 200° C. To remove residues of the heated solvent was evacuated three times before use. After about 30 minutes the PBT (37.2 g) was completely dissolved, giving a clear solution. The stirrer was provided with a torque registration system, which is a good measure for the solution viscosity, and consequently a good indication for the molecular mass of the polymer. After a first addition of 0.57 wt % CBC and 0.18 wt % PBOX with respect to PBT and additional amount of CBC (0.38 wt %) and PBOX (0.20 wt %) was added after one hour. The stirring was continued for about 100 minutes and then the polymers was isolated and analyzed.

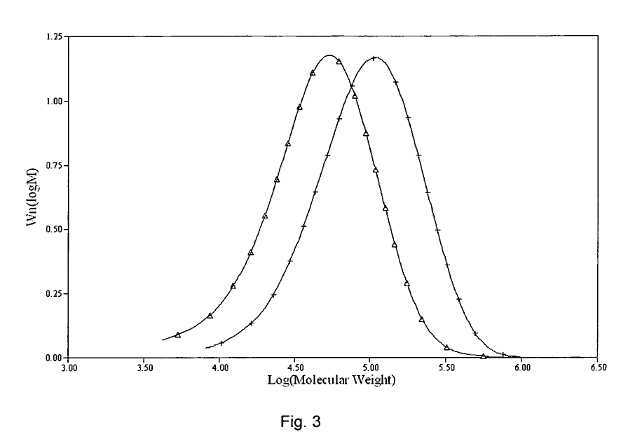

The ηᵣₑₗ of the polymer obtained was 4.58 and the intrinsic viscosity ηᵣₑ₁ is 2.29 dl/g. The SEC measurements revealed that the molecular mass distribution is 1.87, which is less than that of the starting product 1.95 and less than 2. In FIG. 3 the triangles denote the molecular mass distribution of PBT T08200. The line indicated with the + signs exhibits the molecular mass distribution of the PBT extended in solution.

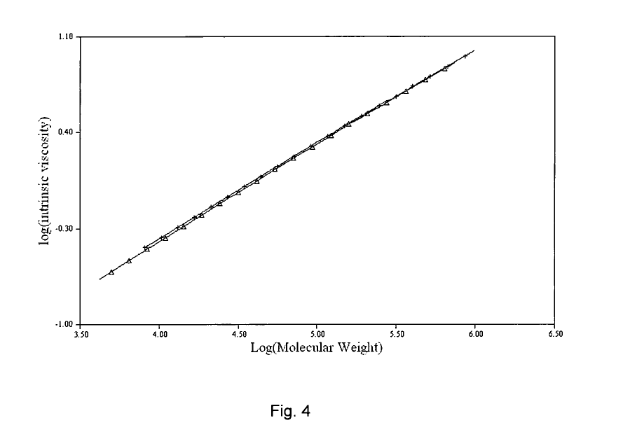

The Mark-Houwink relation (FIG. 4) shows that the starting material and the chain extended material (both indicated as in FIG. 3) are strictly linear, indicating that the method of the invention does not cause any branching.

### Example 10

The experimental conditions were the same as in example 9, but now only CBC is added in a stepwise mode. Every half an hour about 0.24 wt % of CBC with respect to PBT is added, mounting to a total amount of 1.83 wt %. The final viscosity was ηᵣₑₗ=5.8, which corresponds to an intrinsic viscosity of 2.85 dl/g.

### Example 11

PBT T08200 (ηᵣₑₗ=2.40 in m-cresol) from DSM is dried for 18 hours, at 120° C. before use. The hydroxy end group concentration is 39 mmol/kg, the acid end group concentration is 17 mmol/kg and the vinyl end group concentrations is 14.3 mmol/kg.

Dowtherm A, a mixture of diphenylene ether and diphenylene (97.4 g), was added to a reactor, provided with mechanical stirrer and a reflux condenser, and heated to 200° C. To remove residues of the heated solvent was evacuated three times before use. After about 30 minutes the PBT (37.4 g) was completely dissolved, giving a clear solution. The stirrer was provided with a torque registration system, which is a good measure for the solution viscosity, and consequently a good indication for the molecular mass of the polymer. 0.57 wt % CBC, 0.18 wt % PBOX, 0.12 wt % tetramethyldisiloxane and 25 ppm platinum catalyst with respect to PBT was added, and the stirring was continued for about 100 minutes and then the polymers was isolated and analyzed. The final relative viscosity ηᵣₑₗ was 7.5 and the intrinsic viscosity was 3.5 dl/g.

### Example 12

The highly viscous solution obtained in Example 11 was diluted to a 10 w % solution with a mixed solvent of diphenyl ether and biphenyl (73.5:26.5 w/w) and pumped with an hose-pump into an APV twin-screw extruder (D=19 mm, length 25D, 5 heating zones) operated at typically 240° C. and 300 rpm. Directly after the extruder, a spinning gear pump of 0.3 cc was set at 60 rpm to extrude the spinning solution through a spinneret with a diameter of 2 mm. About 4 cm under the spinneret a water bath (about 50 cm deep) was placed and the spun filament was led directly to the bottom of the bath, and guided over a free-rolling wheel to the take-up roll equipped with a bobbin. The speed of the take-up roll was set so that the draw ratio in the air-gap was about 8.4. Spun filaments were dried in a vacuum-oven at 140° C. After drying, the as-spun fiber may still contain a certain amount of solvent (typically >0.5 w %) because this improves drawability.

A bobbin with dried as-spun filament was placed on a feed roll and the filament was led through an electrically heated tubular oven of 90 cm length, and wound on another bobbin on the take-off roll. The draw ratio applied is the ratio of the speeds of the take-off roll and the feed roll. The fibre was drawn 20 times in two steps; first with a draw ratio of 5 at 190° C. (feed velocity 0.5 cm/s), and then with a draw ratio of 4 at 220° C. (feed velocity 0.13 cm/s).

The tensile properties namely the tensile strength (or strength), the tensile modulus (or modulus) and the elongation at break (or eab) were determined on fibre samples with an effective sample length of 278 mm (200 mm distance between clamps plus 78 mm filament on the curved clamp surfaces) and a crosshead speed of 100 mm/min, using a Zwick/Roell Z010 tensile tester with Zwick 8190 pneumatic clamps (based on standard ASTM D885M). On the basis of the measured stress-strain curve the modulus at 0.3% strain was determined (by fitting between 0.25 and 0.35% strain). For calculation of the modulus and strength, the tensile forces measured were divided by the fibre linear density, as determined by weighing 1 metre length of fibre on a micro-balance before and after a series of 3 individual tensile tests; values in GPa are calculated assuming a density of 1.34 g/cm³. In total, at least 12 tests were performed.

The hotdrawn PBT fiber had a tensile strength of 20 cN/dtex and a modulus of 25 N/tex.

### Example 13

According to the same procedure of example 12, an 8 w % solution of high molecular mass PET (IV=5.0 dl/g) in the mixed solvent was spun into a fiber. The dried as-spun fiber was hotdrawn 5× at 190° C. and subsequently 4× at 250° C. The density was assumed to be 1.45 g/cm³.

The hotdrawn PET fiber had a tensile strength of 26 cN/dtex and a modulus of 29 N/tex.

1. A method of increasing the molecular mass of a polycondensate in solution, characterized in that the polycondensate is reacted in solution with at least one chain extender out of the group consisting of bislactams, cyclic amino ethers, siloxanes and thiols, wherein the siloxanes are according to Formula 1 and wherein in said Formula 1, R is an alkyl group with 1 to 6 carbon atoms and π is an integer ranging from 0 to 100.

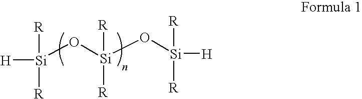

2. Method according to claim 1, wherein the polycondensate in solution is reacted with at least one chain extender out of the group consisting of bislactams and cyclic amino ethers.

3. Method according to claim 1, wherein the polycondensate is polybutylene terephthalate.

4. Method according to claim 1, wherein the bislactams are carbonyl lactams with a lactam ring comprising between 5 and 11 carbon atoms.

5. Method according to claim 4, wherein the carbonyl lactam is carbonyl biscaprolactam.

6. Method according to claim 1, wherein the cyclic amino ether is Phenylene BisOxazoline or Phenylene BisOxazine

7. Method according to claim 1, wherein the siloxane is tetramethyldisiloxane.

8. Method according to claim 1, wherein the polycondensate is reacted in solution with carbonyl biscaprolactam, Phenylene BisOxazine and tetramethyldisiloxane in the presence of a platinum catalyst.

9. A high molecular mass polycondensate in solution, wherein the polycondensate has an intrinsic viscosity as measured in hexafluoroisopropanol of at least 0.9 dl/g and a molecular mass distribution (Mw/Mn) of less than 2.

10. The solution of claim 9 wherein the polycondensate has an intrinsic viscosity of at least 2.5 dl/g.

11. The solution of claim 9 wherein the polycondensate has an intrinsic viscosity of at least 3 dl/g.

12. The solution of claim 9, wherein the polycondensate is polybutylene terephthalate.

13. Shaped article comprising a high molecular mass polycondensate having an intrinsic viscosity as measured in hexafluoroisopropanol of at least 0.9 dl/g and a molecular mass distribution (Mw/Mn) of less than 2.

14. The shaped article of claim 13, wherein the polycondensate has an intrinsic viscosity as measured in hexafluoroisopropanol of higher than 1.5 dl/g.

15. The shaped article of claim 13, wherein the shaped article is a film.

16. The shaped article of claim 13, wherein the shaped article is a fiber.

17. A process for the manufacture of a high molecular mass polycondensate shaped article wherein the solution of claim 9 is used.

18. The process according to claim 17, wherein the high molecular mass polycondensate shaped article is a multifilament polycondensate yarn.

19. A filament obtainable by extruding the solution of claim 9 through a spinneret or a slot die to form a hot fluid filament, by transporting said hot fluid filament via an air-gap through air into a cooling bath to form a gel filament, optionally removing residual solvent from the gel filament, and drawing the gel filament at least 4 times.

20. The filament of claim 19, wherein the gel filament is drawn at least 15 times.

21. A polybutylene terephthalate multifilament yarn containing at least 20 filaments, the yarn being made from polybutylene terephthalate of an IV of at least 1.5 dl/g and a molecular mass distribution of less than 2.
